(19) United States
(12) Patent Application Publication
(10) Pub. No.: US 2024/0289944 A1
(43) Pub. Date: Aug. 29, 2024

(54) INSPECTION APPARATUS AND METHOD FOR CONTROLLING INSPECTION APPARATUS

(71) Applicant: CANON KABUSHIKI KAISHA, Tokyo (JP)

(72) Inventor: SEIJIRO IMAI, Ibaraki (JP)

(21) Appl. No.: 18/584,851

(22) Filed: Feb. 22, 2024

(30) Foreign Application Priority Data
Feb. 27, 2023 (JP) 2023-027945

(51) Int. Cl. G06T 7/00; H04N 1/00

(52) U.S. Cl. CPC G06T 7/001; H04N 1/00015; H04N 1/00029; H04N 1/00045; G06T 2207/10024; G06T 2207/30144; G06T 2207/30168

(57) ABSTRACT

An inspection apparatus connectable with a printing apparatus configured to print an image on a recording sheet to generate a print product, includes one or more controllers having one or more processors and one or more memories, the one or more controllers being configured to register a correct answer image, identify an item diagnosable in image diagnosis processing based on information about a print setting of the print product, and perform first image diagnosis processing to identify a defective portion of the printing apparatus based on a read image generated by reading the print product and the correct answer image, wherein the inspection apparatus performs the first image diagnosis processing on the identified diagnosable item and does not perform the first image diagnosis processing on an item other than the diagnosable item.

### BACKGROUND

### Field of the Disclosure

The present disclosure relates to an inspection apparatus and a method for controlling of an inspection apparatus.

### Description of the Related Art

There has recently been developed a system capable of reading a print product output from a printing apparatus by using a sensor, subjecting read image data to image processing, comparing the image data with original print data, and detecting printing failures, such as stains, white spots, and skew.

In some cases, such printing failures may be caused by a component in the printing apparatus that has been degraded due to use of the printing apparatus in a stressful way for a long period of time. An image diagnosis function has been developed to address such cases. The image diagnosis function prints a dedicated chart for facilitating identifying a phenomenon that is a print failure, and reads the chart by using a sensor to identify the phenomenon that is a print failure and the cause of the failure. In an image diagnosis using the dedicated chart, a device outputs a chart with which image diagnosis items that are inspection targets can be diagnosed, and performs the image diagnosis based on a result of reading the chart. Such an image diagnosis has an issue that materials, such as sheets and toners, and time are wastefully used because a chart having all patterns required for the diagnosis is printed for the diagnosis. Japanese Patent Application Laid-Open No. 2019-133020 proposes a technique for reducing printing time of printing a diagnosis chart and amounts of materials, such as sheets and toners, by collectively printing chart patterns for a plurality of image diagnosis items on a small number of pages for a purpose of reducing downtime in the image diagnosis.

### SUMMARY

As a form of implementing an image diagnosis function, there is assumed a form of implementing the image diagnosis based on a result of reading an output deliverable in a regular print job or inspection job without using a dedicated chart. In a case where the image diagnosis is performed based on image data input by a user, the image diagnosis cannot be performed for some image diagnosis items depending on the contents of the image data. With monochromatic image data, for example, a failure of the printing apparatus related to colors such as yellow, cyan, and magenta cannot be detected, and with text data, a cause of a defect such as streaks and spots is difficult to be detected. Since these diagnosis items for which the image diagnosis cannot be performed have been subjected to image diagnosis processing, an excessive load and processing time have occurred.

According to embodiments of the present disclosure, an inspection apparatus connectable with a printing apparatus configured to print an image on a recording sheet to generate a print product, includes one or more controllers having one or more processors and one or more memories, the one or more controllers being configured to register a correct answer image, identify an item diagnosable in image diagnosis processing based on information about a print setting of the print product, and perform first image diagnosis processing to identify a defective portion of the printing apparatus based on a read image generated by reading the print product and the correct answer image, wherein the inspection apparatus performs the first image diagnosis processing on the identified diagnosable item and does not perform the first image diagnosis processing on an item other than the diagnosable item.

Further features of the present disclosure will become apparent from the following description of exemplary embodiments with reference to the attached drawings.

### BRIEF DESCRIPTION OF THE DRAWINGS

FIG. 1 illustrates an overall hardware configuration of an image processing system.

FIG. 2 is a block diagram illustrating a system configuration of the image processing system.

FIG. 3 is a cross-sectional view illustrating an image forming apparatus.

FIGS. 4A and 4B illustrate examples of user interfaces (UIs) of inspection job result screens.

FIG. 5 illustrates an example of a screen for presetting image diagnosis items.

FIGS. 6A, 6B, and 6C illustrate examples of UIs of image diagnosis result screens.

FIG. 7 is a flowchart illustrating processing for registering a correct answer image for an inspection job according to an exemplary embodiment.

FIG. 8 is a flowchart illustrating processing for performing inspection and image diagnosis according to the exemplary embodiment.

### DESCRIPTION OF THE EMBODIMENTS

Exemplary embodiments of the present disclosure will be described below with reference to the accompanying drawings. The following exemplary embodiments do not limit the present disclosure. Not all the combinations of the features described in the exemplary embodiments are indispensable to the solution for the present disclosure. An external controller according to the present exemplary embodiment may also be referred to as an image processing controller, digital front end (DFE), or print server. An image forming apparatus may also be referred to as a multifunction peripheral (MFP).

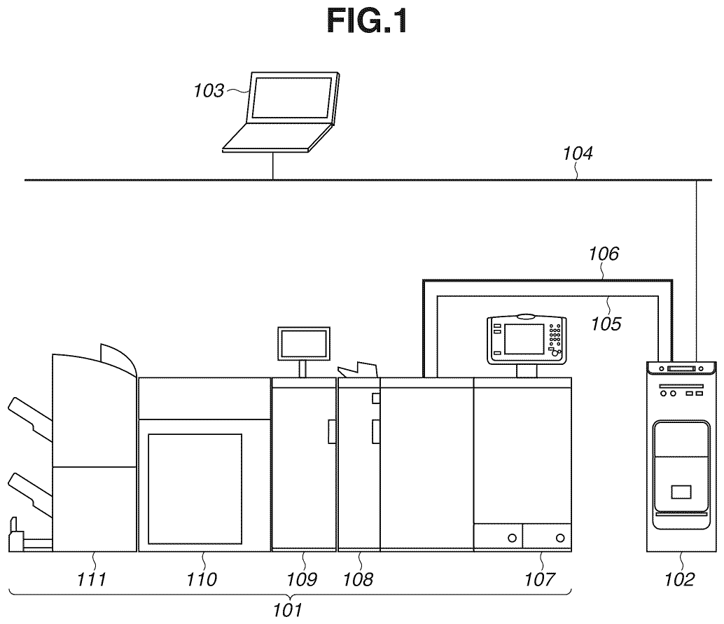

FIG. 1 illustrates an overall hardware configuration of an image processing system according to the present exemplary embodiment. The image processing system includes an image forming apparatus 101 and an external controller 102. The image forming apparatus 101 and the external controller 102 are communicably connected with each other via an internal local area network (LAN) 105 and a video cable 106. The external controller 102 is communicably connected with a personal computer (PC) 103 via an external LAN 104. The PC 103 issues a print instruction to the external controller 102.

The PC 103 is installed with a printer driver having a function of converting print data into a printing description language processable by the external controller 102. A user who wants to perform printing can issue a print instruction from various applications via the printer driver. The printer driver transmits print data to the external controller 102 based on the print instruction from the user. Upon reception of the print instruction from the PC 103, the external controller 102 subjects the print data to data analysis and rasterization processing and then inputs the print data to issue a print instruction to the image forming apparatus 101. The external controller 102 inputs the print data to the image forming apparatus 101 via the internal LAN 105 and inputs the rasterized image data thereto via the video cable 106.

The image forming apparatus 101 will be described now. The image forming apparatus 101 is connected with a plurality of apparatuses having different functions and is configured to perform complicated print processing including bookbinding.

A printing apparatus 107 forms an image by applying toners to a sheet conveyed from a sheet feeding unit located at a lower part of the printing apparatus 107. Although in the following descriptions, it is described that print sheets are used, printing media other than the print sheets can also be used.

A configuration and an operating principle of the printing apparatus 107 will be described below. The printing apparatus 107 irradiates a photosensitive drum with light, such as a laser beam, modulated based on image data and reflected by a rotating polygon mirror, as scanning light.

An electrostatic latent image formed on the photosensitive drum by the laser beam is developed with toner. A generated toner image is transferred onto a sheet stuck on a transfer drum. The printing apparatus 107 sequentially performs a series of image forming processes for yellow (Y), magenta (M), cyan (C), and black (K) toners to form a full color image on the sheet. The sheet with the full color image formed thereon on the transfer drum is conveyed to a fixing unit. The fixing unit includes a roller and a belt, and includes a heat source, such as a halogen heater, inside the roller. The fixing unit melts the toners on the sheet on which the toner image has been transferred with heat and pressure to fix the toners to the sheet. An inserter 108 is an apparatus for inserting an insertion sheet. The inserter 108 enables inserting a sheet at a desired position into a group of sheets printed by and conveyed from the printing apparatus 107.

An inspection apparatus 109 reads an image of a conveyed sheet (print product) and compares generated image data with preregistered reference image data to determine whether the printed image is normal. Print products having been subjected to the determination about normality are discriminated between a normal print product and a failed print product and are discharged in separate ways.

A large-capacity stacker 110 is an apparatus capable of containing a large number of sheets in a stacked manner. A finisher 111 is an apparatus that applies finishing processing to the conveyed sheets. The finisher 111 can apply the finishing processing, such as stapling, punching, and saddle stitching binding, to the sheets and discharge the processed sheets to a discharge tray.

While the image processing system illustrated in FIG. 1 has a configuration where the external controller 102 is connected with the image forming apparatus 101, the present exemplary embodiment is not limited thereto.

More specifically, the image forming apparatus 101 may be connected to the external LAN 104, and the PC 103 may transmit print data processable by the image forming apparatus 101 thereto. In this case, the image forming apparatus 101 performs the data analysis and rasterization processing before performing the print processing.

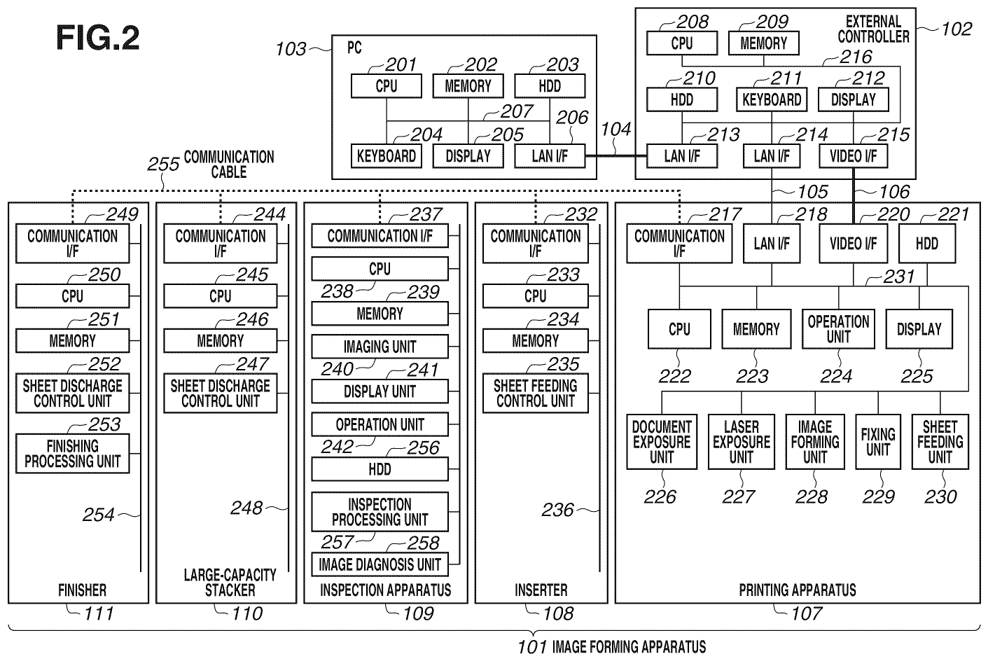

FIG. 2 is a block diagram illustrating a system configuration including the image forming apparatus 101, the external controller 102, and the PC 103.

First, the configuration of the printing apparatus 107 of the image forming apparatus 101 will be described. The printing apparatus 107 of the image forming apparatus 101 includes a communication interface (I/F) 217, a LAN I/F 218, a video I/F 220, a hard disk drive (HDD) 221, a central processing unit (CPU) 222, a memory 223, an operation unit 224, and a display 225. The printing apparatus 107 of the image forming apparatus 101 further includes a document exposure unit 226, a laser exposure unit 227, an image forming unit 228, a fixing unit 229, and a sheet feeding unit 230. These components are connected with each other via a system bus 231.

The communication I/F 217 is connected with the inserter 108, the inspection apparatus 109, the large-capacity stacker 110, and the finisher 111 via a communication cable 255, and performs communication to control these apparatuses.

The LAN I/F 218 is connected with the external controller 102 via the internal LAN 105 to communicate print data and the like.

The video I/F 220 is connected with the external controller 102 via the video cable 106 to communicate rasterized image data and the like.

The HDD 221 is a storage device for storing programs and data. The CPU 222 comprehensively controls image processing and printing based on the programs stored in the HDD 221. The memory 223 stores programs required for the CPU 222 to perform various kinds of processing as well as image data and operates as a work area.

The operation unit 224 receives inputs of various settings and operation instructions from the user. The display 225 displays setting information and a print job processing status of the image forming apparatus 101. The document exposure unit 226 performs processing for reading a document when a copy function or a scanner function is used.

The document exposure unit 226 reads document data by capturing an image of a document by using a charge-coupled device (CCD) camera while irradiating a sheet placed by the user with light of an exposure lamp.

The laser exposure unit 227 performs primary charging to irradiate the photosensitive drum with a laser beam and performs laser exposure to transfer a toner image. Firstly, the laser exposure unit 227 performs the primary charging to charge the surface of the photosensitive drum to a uniform negative potential. Next, the laser exposure unit 227 irradiates the photosensitive drum with a laser beam by a laser driver while adjusting the reflection angle using the polygon mirror. Thus, negative charges on irradiated portions are neutralized, and an electrostatic latent image is formed. The image forming unit 228 is an apparatus for transferring toner to the sheet. The image forming unit 228 includes a developing unit, a transfer unit, and a toner supply unit and transfers the toner on the photosensitive drum to the sheet.

The developing unit applies negatively charged toner from a developing cylinder to the electrostatic latent image on the surface of the photosensitive drum to visualize the image. The transfer unit performs primary transfer for applying a positive potential to a primary transfer roller to transfer the toner on the surface of the photosensitive drum to a transfer belt, and performs secondary transfer for applying a positive potential to a secondary transfer roller to transfer the toner on the transfer belt to the sheet. The fixing unit 229 is an apparatus that melts and fixes the toner on the sheet with heat and pressure. The fixing unit 229 includes a heater, a fixing belt, and a pressurization belt. The sheet feeding unit 230 is an apparatus that supplies a sheet and controls a sheet feed operation and a conveyance operation by using rollers and various sensors.

Next, the configuration of the inserter 108 of the image forming apparatus 101 will be described. The inserter 108 of the image forming apparatus 101 includes a communication I/F 232, a CPU 233, a memory 234, and a sheet feeding control unit 235 which are connected with each other via a system bus 236. The communication I/F 232 is connected with the printing apparatus 107 via the communication cable 255 and performs communication required for control operations. The CPU 233 performs various control operations required for sheet feeding according to control programs stored in the memory 234. The memory 234 is a storage device storing the control programs. The sheet feeding control unit 235 controls the feeding and conveyance of the sheet conveyed from a sheet feeding portion of the inserter 108 and from the printing apparatus 107 while controlling the rollers and sensors based on instructions from the CPU 222.

Next, the configuration of the inspection apparatus 109 of the image forming apparatus 101 will be described. The inspection apparatus 109 of the image forming apparatus 101 includes a communication I/F 237, a CPU 238, a memory 239, an imaging unit 240, a display unit 241, an operation unit 242, and an HDD 256 which are connected with each other via a system bus. The communication I/F 237 is connected with the printing apparatus 107 via the communication cable 255 to perform communication required for control operations.

A reference image to be used for inspection is also received from the printing apparatus 107 via the communication cable 255 and the communication I/F 237 and then stored in the HDD 256. The CPU 238 performs various control operations required for inspection according to control programs stored in the memory 239. The memory 239 is a storage device storing the control programs. However, reception and storage of the reference image are not limited thereto. For example, the inspection apparatus 109 may include a LAN I/F and may be configured to communicate with the external controller 102 via the internal LAN 105. In this case, the inspection apparatus 109 can be operated in a similar manner by receiving the reference image from the external controller 102 via the LAN I/F and then storing the reference image in the HDD 256.

The imaging unit 240 captures the conveyed sheet based on an instruction from the CPU 238.

Based on an instruction from the CPU 238, an inspection processing unit 257 compares an image captured by the imaging unit 240 with the reference image stored in the HDD 256 and determines whether an output product satisfies the quality as a deliverable. A deliverable that has failed the inspection is discharged by a sheet discharge control unit 247 of the large-capacity stacker 110 to a tray (e.g., escape tray 346) different from a tray for a deliverable that has passed the inspection.

Based on an instruction from the CPU 238, an image diagnosis unit 258 compares the image captured by the imaging unit 240 with the reference image stored in the HDD 256 and determines whether an image defect of a specific pattern has occurred because of a defective consumable part of the image forming apparatus 101. If an image defect of a specific pattern has occurred, the image diagnosis unit 258 identifies the defective part causing the image defect and displays an operation for resolving the defect, such as a part replacement procedure, on the display unit 241.

The display unit 241 displays inspection results and setting screens. Screens displayed on the display unit 241 are controlled by the CPU 238 as a display control unit. The operation unit 242 is operated by the user and receives instructions for changing the settings of the inspection apparatus 109 and registering the reference image. The HDD 256 stores the reference image. In a case where the HDD 256 is not provided, the reference image may be stored in the HDD 221, and in processing of determining whether a printed image is normal, the reference image may be read from the HDD 221 to the memory 239 to be used in the processing.

Next, a configuration of the large-capacity stacker 110 of the image forming apparatus 101 will be described. The large-capacity stacker 110 of the image forming apparatus 101 includes a communication I/F 244, a CPU 245, a memory 246, and the sheet discharge control unit 247 which are connected via a system bus 248. The communication I/F 244 is connected with the printing apparatus 107 via the communication cable 255 to perform communication required for control operations. The CPU 245 performs various control operations required for sheet discharge according to control programs stored in the memory 246. The memory 246 is a storage device storing the control programs. The sheet discharge control unit 247 performs control operations for conveying the conveyed sheet to a stack tray, an escape tray, or the finisher 111, which is a subsequent apparatus, based on an instruction from the CPU 245.

Next, a configuration of the finisher 111 of the image forming apparatus 101 will be described. The finisher 111 of the image forming apparatus 101 includes a communication I/F 249, a CPU 250, a memory 251, a sheet discharge control unit 252, and a finishing processing unit 253 which are connected with each other via a system bus 254. The communication I/F 249 is connected with the printing apparatus 107 via the communication cable 255 to perform communication required for control operations. The CPU 250 performs various control operations required for finishing and sheet discharge according to control programs stored in the memory 251. The memory 251 is a storage device storing the control programs. The sheet discharge control unit 252 controls the sheet conveyance and discharge operations based on instructions from the CPU 250. The finishing processing unit 253 controls finishing processing, such as stapling, punching, and saddle stitching binding, based on instructions from the CPU 250.

Next, a configuration of the external controller 102 will be described. The external controller 102 includes a CPU 208, a memory 209, an HDD 210, a keyboard 211, a display 212, LAN I/Fs 213 and 214, and a video I/F 215 which are connected via a system bus 216. The CPU 208 comprehensively performs processing for receiving print data from the PC 103, raster image processing (RIP), and processing for transmitting a print job to the image forming apparatus 101 based on programs and data stored in the HDD 210.

The memory 209 stores programs and data required for the CPU 208 to perform various kinds of processing and operates as a work area. The HDD 210 stores programs and data required for print processing and the like. The keyboard 211 is a unit for inputting operation instructions for the external controller 102. The display 212 displays information about an application executed by the external controller 102 by using video signals of still and moving images. The LAN I/F 213 is connected with the PC 103 via the external LAN 104 to communicate print instructions and the like. The LAN I/F 214 is connected with the image forming apparatus 101 via the internal LAN 105 to communicate a print job and the like as a print instruction. The video I/F 215 is connected with the image forming apparatus 101 via the video cable 106 to communicate rasterized image data and the like.

Next, a configuration of the PC 103 will be described. The PC 103 includes a CPU 201, a memory 202, an HDD 203, a keyboard 204, a display 205, and a LAN I/F 206 which are connected via a system bus 207. The CPU 201 generates print data and issues a print instruction based on a document processing program stored in the HDD 203.

The CPU 201 comprehensively controls the devices connected to the system bus 207. The memory 202 stores programs and data required for the CPU 201 to perform various kinds of processing and operates as a work area. The HDD 203 stores programs and data required for operations such as print processing. The keyboard 204 is a device for inputting an operation instruction for the PC 103. The display 205 displays information about the application executed by the PC 103 by using video signals of still and moving images. The LAN I/F 206 is connected to the external LAN 104 to communicate print instructions and the like.

While, in the above descriptions, the external controller 102 and the image forming apparatus 101 are connected by the internal LAN 105 and the video cable 106, these two apparatuses only need to be configured to be able to transmit and receive data required for printing. For example, these apparatuses may be connected only by the video cable 106. The memories 202, 209, 223, 234, 239, 246, and 251 only need to be storage devices for storing data and programs. For example, each of these memories may be substituted by a volatile random access memory (RAM), a nonvolatile read only memory (ROM), a built-in HDD, an external HDD, or a universal serial bus (USB) memory.

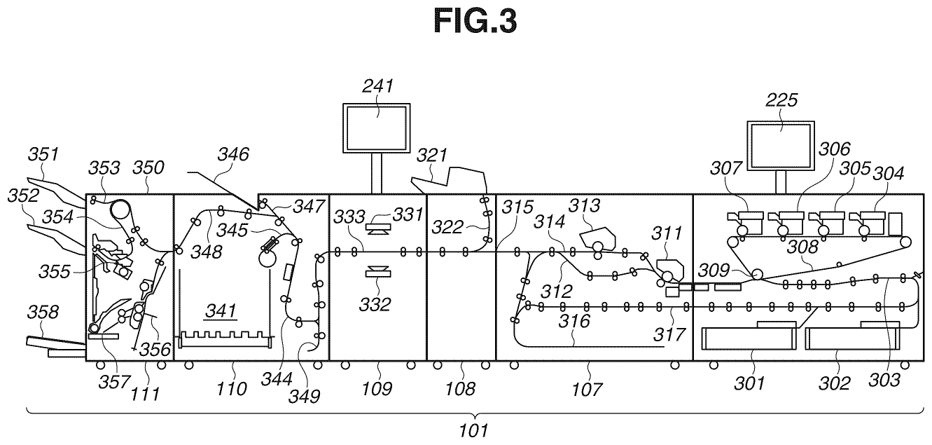

FIG. 3 is a cross-sectional view illustrating a mechanism of the image forming apparatus 101. The printing apparatus 107 forms an image to be printed on a sheet. Sheet feed decks 301 and 302 can store various types of sheets. For each of the sheet feed decks 301 and 302, information about the stored sheets (sheet size and sheet type) can be set from the operation unit 224 of the printing apparatus 107.

In each of the sheet feed decks 301 and 302, only one top sheet is separated from the stored sheets and is conveyed to a sheet conveyance path 303. Development stations 304, 305, 306, and 307 form toner images by using Y, M, C, and K color toners, respectively, to form a color image. The formed toner images are primarily transferred to an intermediate transfer belt 308 rotating in the clockwise direction in FIG. 3. The toner images are transferred to the sheet conveyed from the sheet conveyance path 303 at a secondary transfer position 309.

The display 225 displays a printing status and setting information of the image forming apparatus 101. A fixing unit 311 fixes the toner image to a sheet. The fixing unit 311 includes a pressure roller and a heating roller. When the sheet passes between these rollers, the fixing unit 311 melts and pressurizes the toner to fix the toner image to the sheet. The sheet that has passed through the fixing unit 311 is conveyed on a sheet conveyance path 312 to a sheet conveyance path 315.

If the sheet requires additional melting and pressurization for fixing depending on a sheet type, the sheet having passed through the fixing unit 311 is conveyed to a second fixing unit 313 using a sheet conveyance path 314 located above. After being subjected to additional melting and pressurization by the second fixing unit 313, the sheet is conveyed on the sheet conveyance path 314 and then to the sheet conveyance path 315. In a two-sided image forming mode, the sheet is conveyed to a sheet reversing path 316, reversed in the sheet reversing path 316, and then conveyed to a two-sided conveyance path 317. Then, image transfer is performed on the second surface of the sheet at the secondary transfer position 309.

The inserter 108 inserts an insertion sheet. The inserter 108 includes an inserter tray 321 and inserts the insertion sheet, which is supplied to the inserter tray 321, via a sheet conveyance path 322 into the main conveyance path. This enables inserting the insertion sheet at a desired position into a series of sheets conveyed from the printing apparatus 107, and conveying the sheets to a subsequent apparatus.

The sheet having passed the inserter 108 is conveyed to the inspection apparatus 109. The inspection apparatus 109 includes cameras 331 and 332 disposed to face each other. The camera 331 is used to read the upper surface of the sheet, and the camera 332 is used to read the lower surface thereof. The inspection apparatus 109 reads an image on the sheet by using the cameras 331 and 332 at a timing when the sheet conveyed on a sheet conveyance path 333 reaches a predetermined position, and can determine whether the image on the image is normal. The display unit 241 displays a result of the inspection performed by the inspection apparatus 109.

The large-capacity stacker 110 can contain a large number of sheets in a stacked manner.

The large-capacity stacker 110 includes a stack tray 341 as a tray on which a sheet determined to be a normal sheet (print product) by the inspection apparatus 109 is stacked. The sheet having passed through the inspection apparatus 109 enters the large-capacity stacker 110 on a sheet conveyance path 344. The sheet on the sheet conveyance path 344 passes through a sheet conveyance path 345 and then is stacked on the stack tray 341.

The large-capacity stacker 110 further includes the escape tray 346 as a sheet discharge tray. The escape tray 346 is used to discharge a sheet determined to be a failed sheet (print product) by the inspection apparatus 109. When a sheet is to be discharged to the escape tray 346, the sheet is conveyed from the sheet conveyance path 344 through a sheet conveyance path 347 and then to the escape tray 346. When a sheet is to be conveyed to a post-processing apparatus in a stage subsequent to the large-capacity stacker 110, the sheet is conveyed on a sheet conveyance path 348. A reversing unit 349 flips a sheet. The reversing unit 349 is used when the sheet is to be stacked on the stack tray 341.

When a sheet is to be stacked on the stack tray 341 so that the orientation of an input sheet coincides with the orientation of the sheet when output, the reversing unit 349 once flips the sheet. When a sheet is to be conveyed to the escape tray 346 or the subsequent post-processing apparatus, the reversing unit 349 does not perform a reversing operation and discharges the sheet as it is without flipping.

The finisher 111 applies finishing processing to the conveyed sheet according to the function specified by the user. More specifically, the finisher 111 has a finishing function such as stapling (one- or two-position binding), (two- or three-hole) punching, and saddle stitching binding. The finisher 111 includes two sheet discharge trays 351 and 352 and discharges a sheet to the sheet discharge tray 351 through a sheet conveyance path 353. However, finishing processing such as stapling cannot be performed by using the sheet conveyance path 353.

When the finishing processing such as stapling is to be performed, a sheet is conveyed on a sheet conveyance path 354. A processing unit 355 performs the finishing function specified by the user and outputs the sheet to the sheet discharge tray 352. The sheet discharge trays 351 and 352 can be raised and lowered individually. For example, the sheet discharge tray 351 can be lowered, and the sheet having been subjected to the finishing processing by the processing unit 355 can be stacked on the sheet discharge tray 351. When saddle stitching binding is specified, a saddle stitching processing unit 356 performs stapling at the center of sheets, folds the sheets in two, and discharges the sheets to a saddle stitching binding tray 358 through a sheet conveyance path 357. The saddle stitching binding tray 358 includes a conveyor belt configured to convey a saddle-stitching-bound sheet bundle stacked on the saddle stitching binding tray 358 to the left.

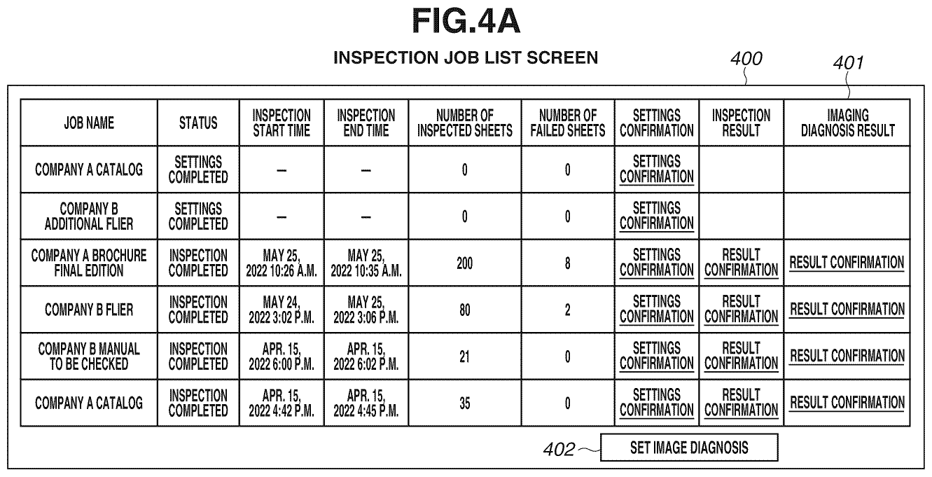

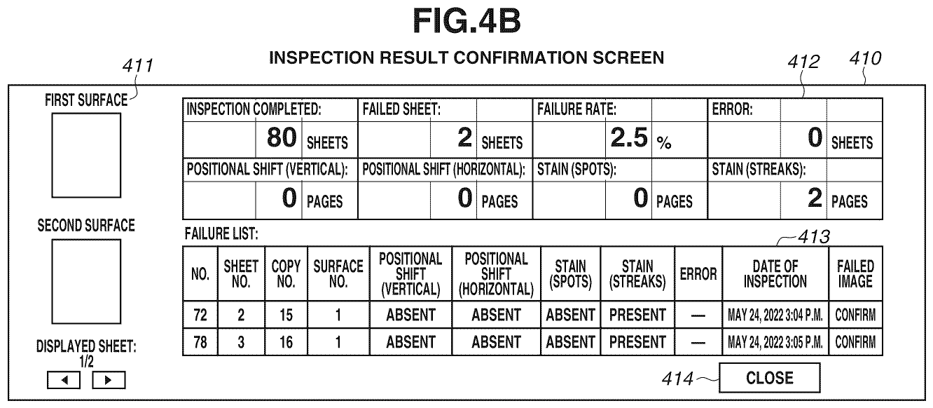

FIGS. 4A and 4B illustrate examples of a job list screen and a result screen, respectively, of automatic inspection according to the present exemplary embodiment displayed on the display unit 241. The result screen of automatic inspection may be displayed on the display 225 of the printing apparatus 107 or the display 212 of the external controller 102.

FIG. 4A illustrates an example of a job list screen of automatic inspection and image diagnosis. A job list screen 400 includes an inspection job list 401 and a “Set Image Diagnosis” button 402. The inspection job list 401 displays a list of jobs registered as an inspection and image diagnosis job. The inspection job list 401 includes a job name for identifying each job, a status indicating the execution status, an inspection start time, an inspection end time, the number of inspected sheets, and the number of failed sheets of each inspection and image diagnosis job. The inspection job list 401 also includes a setting confirmation link to transition to a screen for confirming the settings of a selected inspection job, a result confirmation link to transition to an inspection result confirmation screen 410, and a result confirmation link to transition to an image diagnosis result confirmation screen 610. The inspection job list 401 includes a job that has already been inspected and a job that has been set but has not been inspected yet. The already inspected job has a status “Inspection Completed”, an inspection start time, an inspection end time, the number of inspected sheets, the number of failed sheets, and a link to transition to the inspection result confirmation screen 410. The already inspected job also has a link to the image diagnosis result confirmation screen 610 displaying a result of the image diagnosis performed at the same time as the inspection.

The job that has not been inspected yet has the status “Settings Completed” and indefinite values for other items. The “Set Image Diagnosis” button 402 is used to display an image diagnosis presetting screen. When this button is selected, the job list screen 400 transitions to an image diagnosis setting screen 500.

FIG. 4B illustrates an example of a screen displayed for confirmation of inspection results. The inspection result confirmation screen 410 displays details of an inspection result of a selected job when the result confirmation link of the inspected job in the inspection job list 401 is selected. FIG. 4B illustrates an example in which 16 copies of a 5-page print job (a total of 80 pages) are printed and two pages failed the inspection. The inspection result confirmation screen 410 include a failed sheet thumbnail 411, a tabulated inspection result 412, a failure list 413, and a Close button 414. The failed sheet thumbnail 411 displays read images of the front and rear surfaces of the sheet that has failed the inspection. If a plurality of sheets fails the inspection, selection buttons below the thumbnail can be selected to switch to images of other sheets that have failed the inspection. The tabulated inspection result 412 displays tabulated inspection results of inspected jobs. The tabulated inspection result 412 includes the number of inspected pages, the number of pages that have failed the inspection, a failure rate, the total number of printing and reading errors, and the total number of occurrences of defect factors in the inspection, such as a positional shift (vertical), positional shift (horizontal), stain (spots), and stain (streaks). The failure list 413 includes, for each failed page, a page number in the entire inspection job, a sheet number in the job, a copy number, a front or rear surface, whether each defect factor is present or absent, the date of inspection, and a link for confirming the read image of the failed page. When the link for confirming the read image of the failed page is selected, a read image of the failed page appears. The Close button 414 is used to issue an instruction for closing the inspection result confirmation screen 410. When the Close button 414 is pressed, the job list screen 400, which is the screen before transition, appears.

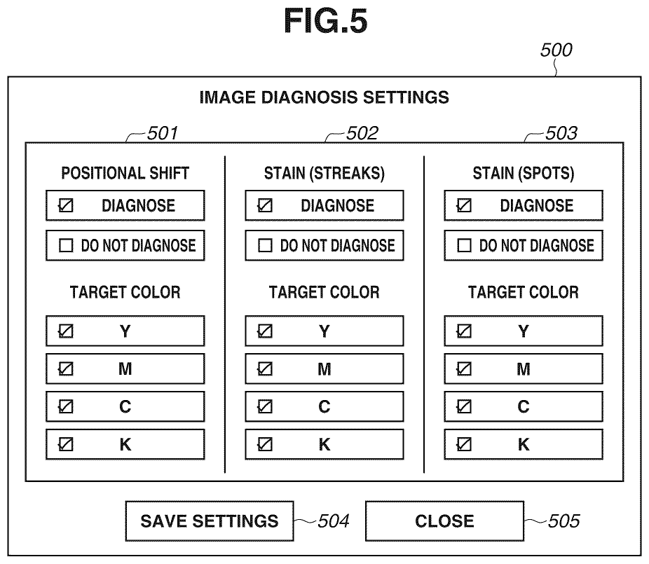

FIG. 5 illustrates an example of a screen displayed for presetting the image diagnosis, displayed on the display unit 241. Such an image diagnosis environment setting screen may be displayed on the display 225 of the printing apparatus 107 or the display 212 of the external controller 102. When performing the image diagnosis at the same time as an inspection job, the user specifies in advance an item to be subjected to the image diagnosis in this screen. When performing the image diagnosis, the CPU 238 determines whether each item set in this screen is diagnosable based on a diagnosis target user image. The image diagnosis setting screen 500 includes image diagnosis target settings 501, 502, and 503, a Save Settings button 504, and a Close button 505. The image diagnosis target settings 501, 502, and 503 are displayed to specify target factors for which the image diagnosis is to be performed. The image diagnosis target settings 501, 502, and 503 enable settings whether to perform image diagnoses for a positional shift factor, a stain (streaks) factor, and a stain (spots) factor. Each item has “Diagnose” and “Do Not Diagnose” settings. If “Diagnose” is set, a target color(s) can be set for each image diagnosis item. As a detailed setting, a color(s) to be used for image formation can be individually set, i.e., the yellow (Y), magenta (M), cyan (C), and black (K) toners can be individually set. When the user presses a toner color, the toner color is selected. When the user presses the toner color again, the toner color is deselected. When the user presses the Save Settings button 504, the CPU 238 stores the settings in this screen, closes the image diagnosis setting screen 500, and changes the display to the screen before transition. When the user presses the Close button 505, the CPU 238 closes the image diagnosis setting screen 500 without storing the settings in this screen, and changes the display to the screen before transition.

While, in the present exemplary embodiment, items preselected by the user are subjected to the image diagnosis, the CPU 238 may determine whether predetermined image diagnosis items can be subjected to the image diagnosis without a presetting.

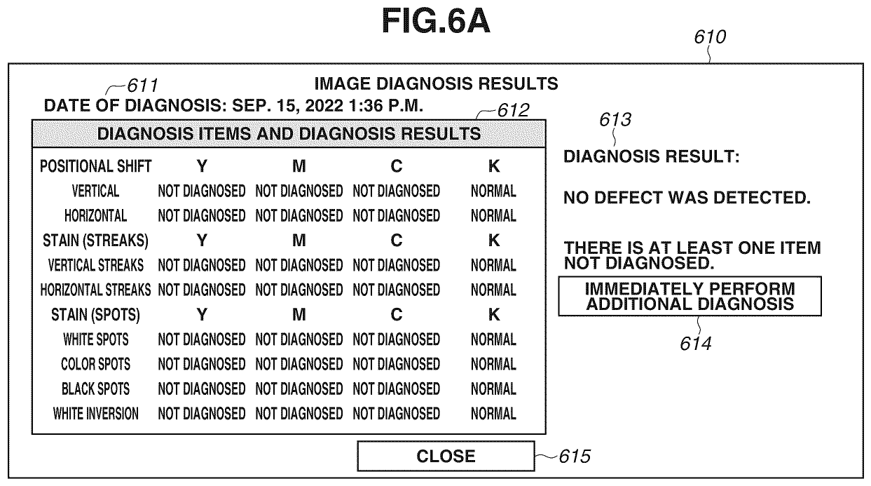

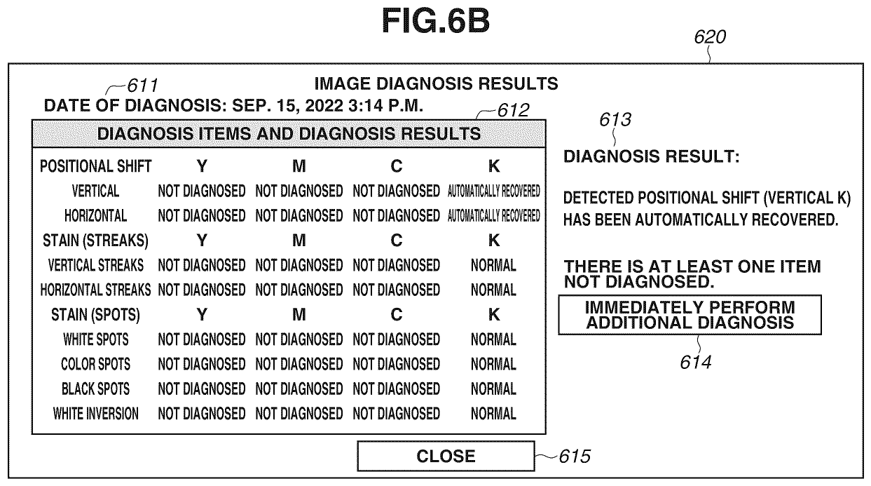

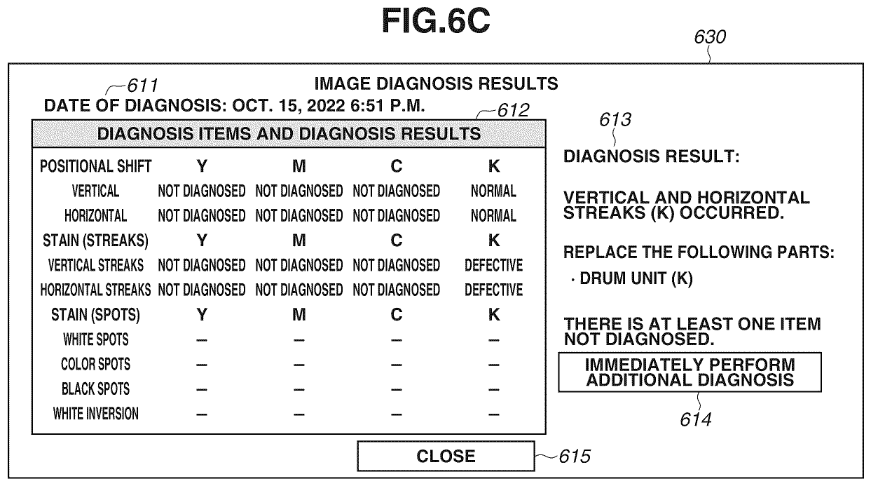

FIGS. 6A to 6C illustrate examples of screens displayed to present results of performing the image diagnosis, displayed on the display unit 241. An environment setting screen for the image diagnosis may be displayed on the display 225 of the printing apparatus 107 or the display 212 of the external controller 102. FIGS. 6A to 6C illustrate display examples of diagnosis results for a job in which the image diagnosis is performed based on the same monochromatic image data.

The image diagnosis result confirmation screen 610 in FIG. 6A is displayed when an image diagnosis result for a diagnosis target is successful. A date of diagnosis 611 displays the date and time when the image diagnosis is performed and the result is determined. A diagnosis item result 612 displays detailed diagnosis results for diagnosis items subjected to the image diagnosis. The diagnosis item result 612 displays more detailed results for each diagnosis item set in the image diagnosis target settings 501, 502, and 503. The diagnosis item result 612 displays the result of each diagnosis item in five different patterns: “Normal”, “Defective”, “Automatically Recovered”, “Not Diagnosed”, and “-”. “Normal” indicates that no defect is detected as a result of performing the image diagnosis. “Defective” indicates that a defect is detected as a result of performing the image diagnosis. “Automatically Recovered” indicates that the detected defect has been automatically recovered. “Not Diagnosed” indicates an undiagnosable item in the user image. “-” indicates an item preset as a non-diagnosis target item by the user. The image diagnosis result confirmation screen 610 is a diagnosis result screen on a job basis. Thus, if a job includes a plurality of pages, “Normal” is displayed if no defect is detected in all pages other than pages on which a certain item is undiagnosable, and “Defective” is displayed if a certain defect is detected on any one page in the job. “Not Diagnosed” is displayed if a certain diagnosis item is determined to be an undiagnosable item on all pages in the job.

An image diagnosis result 613 displays the result of the image diagnosis in consideration of the diagnosis item result 612. This field displays a message as a specific statement that allows the user to easily understand the result. An “Immediately Perform Additional Diagnosis” button 614 is used to perform diagnosis based on an output diagnosis chart for an item not having been diagnosed based on the image data in a certain image diagnosis job. The “Immediately Perform Additional Diagnosis” button 614 is displayed only if there is an item with the diagnosis result “Not Diagnosed”. If the user presses the button 614, the diagnosis item not having been diagnosed based on the user image data in the certain image diagnosis job can be diagnosed in a complementary way through a chart diagnosis. The chart for the chart diagnosis performed by pressing the button 614 may include all diagnosis items or only diagnosis items with the status “Not Diagnosed” obtained as a result of the image diagnosis. The image data of the chart is stored in the HDD 256 of the inspection apparatus 109. When the button 614 is pressed, the CPU 238 transmits the data of the chart to the printing apparatus 107 via the communication I/F 217, and the printing apparatus 107 prints the chart. While, in the present exemplary embodiment, the image diagnosis processing, which is performed by printing a diagnosis chart, is described as being performed by pressing the button 614, the present exemplary embodiment is not limited thereto. For example, if there is an undiagnosable item in the image diagnosis processing, the CPU 238 may automatically perform the image diagnosis processing based on a diagnosis chart including all of Y, M, C, and K items each time the print job is completed. When there is a diagnosis item not having been diagnosed for a certain period of time, the CPU 238 may automatically perform the image diagnosis processing based on the diagnosis chart including all of the Y, M, C, and K items. In the example of the image diagnosis result confirmation screen 610, the results of Y, M, and C diagnosis items are displayed as “Not Diagnosed” since the diagnosis target is a monochromatic image. When the user presses the button 614, the image forming apparatus 101 outputs Y, M, and C diagnosis charts for the positional shift and the stain (streaks/spots), and the CPU 238 performs the image diagnosis for the above-mentioned items.

When the user presses a Close button 605, the CPU 238 closes the image diagnosis result confirmation screen 610 and changes the display to the screen before transition. In the present exemplary embodiment, a button needs to be an object that can be pressed and, for example, a hardware button is also applicable.

A image diagnosis result confirmation screen 620 in FIG. 6B illustrates an example of a screen displayed when the CPU 238 detects, as a result of performing the image diagnosis, a printing failure due to a positional shift and automatically recovers the positional shift. The CPU 238 displays “Automatically Recovered” for the items “Positional Shift (Vertical and Horizontal)” that are automatic recovery target items in the diagnosis item result 612, and displays the contents of automatic recovery in the image diagnosis result 613. The automatic recovery herein refers to a method in which the device automatically performs reset and adjustment operations and automatically adjusts a predetermined parameter, thus automatically recovering a detected printing failure.

A image diagnosis result confirmation screen 630 in FIG. 6C illustrates an example of a screen displayed when the CPU 238 detects, as a result of performing the image diagnosis, vertical and horizontal streaks that are among the items of “Stain (Streaks)”. The CPU 238 displays “Defective” for the items “Stain (Streaks)”-“Vertical Streaks” and “Horizontal Streaks” in the items of the diagnosis item result 612, and displays the defective diagnosis item as well as the cause of the defect and a measure to take in the image diagnosis result 613. The image diagnosis result confirmation screen 630 illustrates a case where the user does not set “Stain (Spots)” as an image diagnosis target in the image diagnosis setting screen 500. Since “Stain (Spots)” is excluded from diagnosis items subjected to the determination of whether the image diagnosis is possible based on user data, the CPU 238 displays “-” as a diagnosis result for “Stain (Spots)”.

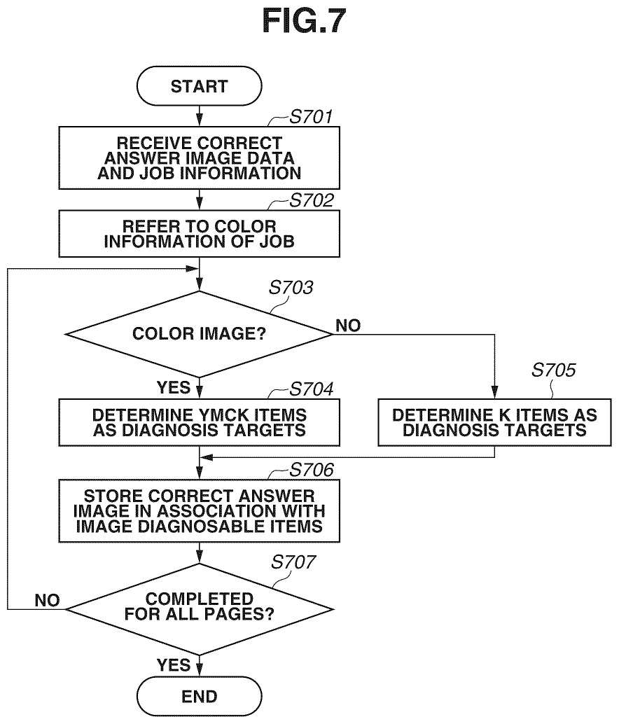

FIG. 7 is a flowchart illustrating processing for registering a correct answer image for the inspection. A series of processes of this flowchart is implemented by the CPU 238 of the inspection apparatus 109 existing on the system. The processing on the inspection apparatus 109 is implemented by the CPU 238 executing a control program that is read from the HDD 256 and loaded into the memory 239.

In step S701, the CPU 238 receives correct answer image data and job information from the external controller 102 through the LAN I/Fs via the printing apparatus 107. The job information corresponds to print setting parameters for a job set by the user, and includes a job name and color information of the job. The job information may be attribute information embedded in Page Description Language (PDL) data of an image to be printed.

In step S702, the CPU 238 refers to the color information received in step S701. In step S703, the CPU 238 determines which of color image data and monochromatic image data the correct answer image data is. When a result of the determination in step S703 is color image data (YES in step S703), the processing proceeds to step S704. In step S704, the CPU 238 determines the Y, M, C, and K items among the preset image diagnosis items stored in the HDD 256 as image diagnosable items. The preset image diagnosis items correspond to the items selected by the user in the image diagnosis setting screen 500.

The processing in step S703 and subsequent steps is performed for each page of the image data of the job.

In step S703, when the CPU 238 determines that the correct answer image is monochromatic image data (NO in step S703), the processing proceeds to step S705. In step S705, the CPU 238 determines the K items among the preset image diagnosis items stored in the HDD 256 as image diagnosable items, and determines the Y, M, and C items as image undiagnosable items. In step S706, the CPU 238 stores the result determined in step S704 or S705 in the HDD 256 in association with the job name.

In step S707, when the CPU 238 determines that the processing is not completed for all pages (NO in step S707), the processing returns to step S703 to perform the processing on subsequent pages. When the CPU 238 determines that the processing is completed for all pages (YES in step S707), the processing exits this flowchart.

While the present exemplary embodiment determines which color of an image diagnosis item is to be diagnosed based on the color information of the image data, the image diagnosis item subjected to the determination and the determination method are not limited thereto. The CPU 238 may determine whether a positional shift, a stain, and the like are diagnosable based on a feature quantity of the image data.

While, in the present exemplary embodiment, the case where a correct answer image is generated based on the received correct answer image data has been described, a correct answer image may be generated based on a scan image (read image) generated by scanning a print product. When generating a correct answer image based on the scan image, in step S701, the CPU 238 receives the job information from the external controller 102 through the LAN I/Fs via the printing apparatus 107, and acquires the scan image generated by the imaging unit 240 reading a print product. When registering a correct answer image based on a scan image, the CPU 238 may generate a plurality of scan images and generate the correct answer image based on a representative image selected from among the generated scan images by the user, or combine the plurality of scan images and register a combined image as the correct answer image. The representative image herein refers to an image selected from among the plurality of scan images and serving as a reference image in combining images to obtain a correct answer image.

In FIG. 7, the CPU 238 identifies the image diagnosable items by referring to the color information of the job. However, the CPU 238 may also perform control to identify the image diagnosable items by referring to whether the job is text data.

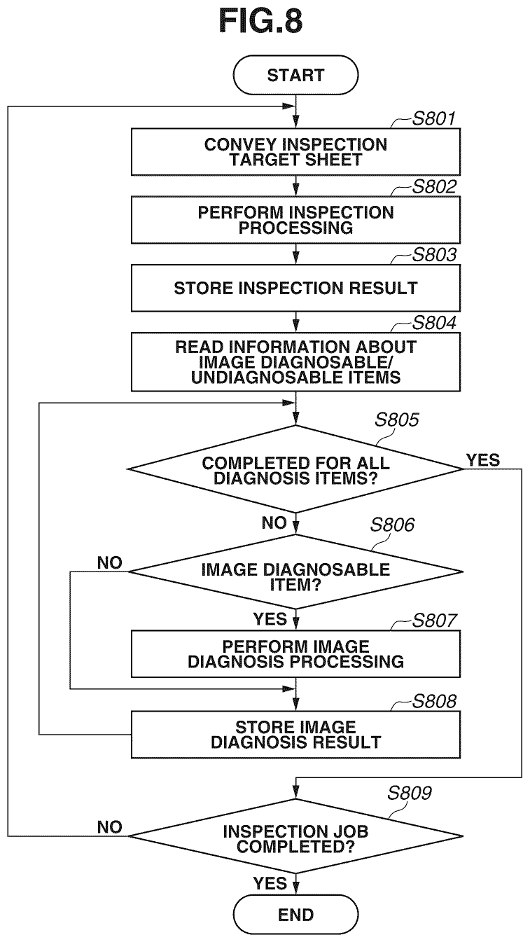

FIG. 8 is a flowchart illustrating processing for performing the image diagnosis subsequent to the inspection processing. A series of processes of this flowchart is implemented by the CPU 238 of the inspection apparatus 109 existing on the system. The processing on the inspection apparatus 109 is implemented by the CPU 238 executing a control program that is read from the HDD 256 and loaded into the memory 239.

When the control program executed by the CPU 238 of the inspection apparatus 109 receives an instruction for starting execution of an inspection job from the user, the external controller 102 issues an instruction for starting printing to the printing apparatus 107. A recording sheet with an image formed thereon by the printing apparatus 107 is conveyed from the printing apparatus 107 to the inspection apparatus 109 via the inserter 108.

In step S801, the CPU 238 conveys a sheet with an inspection target image formed thereon to a conveyance path.

In step S802, the CPU 238 instructs an image reading sensor (reading unit) to read the sheet in synchronization with a sheet conveyance timing and performs an inspection operation. In the inspection operation, the CPU 238 stores a read image in the HDD 256, determines whether a defective image has occurred as an inspection result, and determines a cause of the defect if the defective image has occurred. In step S803, the CPU 238 records the above results as an inspection result. After the CPU 238 records the determined inspection result in the memory 239, the processing proceeds to step S804.

In step S804, the CPU 238 reads the result of the determination about the image diagnosable and undiagnosable items stored in step S706 from the HDD 256 by using the job name of the inspection job as a key.

The processing in step S805 and subsequent steps is performed for each image diagnosis item.

In step S805, the CPU 238 determines whether the inspection is completed for all of the diagnosis items read in step S804. When the inspection is not completed for all of the diagnosis items (NO in step S805), the processing proceeds to step S806.

In step S806, the CPU 238 determines whether the processing target image diagnosis item is a diagnosable item.

When the processing target image diagnosis item is an image diagnosable item (YES in step S806), the processing proceeds to step S807. In step S807, the CPU 238 performs the image diagnosis for the item. When the processing target image diagnosis item is not an image diagnosable item (NO in step S806), the CPU 238 does not perform the image diagnosis for the item. Then, the processing proceeds to step S808.

In step S808, the CPU 238 stores a result of the processing in the HDD 256. When the CPU 238 performs the image diagnosis, the CPU 238 stores the diagnosis result. When the CPU 238 does not perform the image diagnosis, the CPU 238 stores “Not Diagnosed” as a processing result. Then, the processing returns to step S805.

In step S805, when the processing is completed for all of the image diagnosis items (YES in step S805), the processing proceeds to step S809. The CPU 238 completes the processing for each page.

In step S809, the CPU 238 determines whether the processing is completed for all pages of the inspection job.

When the processing is not completed for all pages (NO in step S809), the processing returns to step S801, and the CPU 238 repeats the series of processes. When the processing is completed for all pages (YES in step S809), the processing exits this flowchart.

In the present exemplary embodiment, correct answer data is analyzed in advance when a correct answer image of the inspection job is registered, and the image diagnosis is performed. However, the image data analysis and the image diagnosis may be performed at one time when a normal print job is executed. In this case, the job type and the image data analysis timing are not limited. In the flowchart in FIG. 8, it is illustrated that the CPU 238 performs the image diagnosis processing in step S807 after the inspection processing is performed in step S802. However, the CPU 238 may perform the inspection processing in steps S802 and S803 and the image diagnosis processing in steps S804 to S808 in parallel, or perform the inspection processing after the image diagnosis processing.

As described above, in the image diagnosis using the user data, the image processing system according to the present exemplary embodiment can provide a reliable diagnosis result for a diagnosable item and, for an undiagnosable item, can provide a display that allows the user to understand that the diagnosis has not been performed while reducing redundant processing load. In addition, the image processing system according to the present exemplary embodiment automatically performs the image diagnosis at the same time as the execution of a print job or an inspection job input by the user. This makes it possible to reduce user's time and effort in manually performing the image diagnosis, reduce consumption of sheets and toners through the output of a diagnosis chart, and reduce the device downtime.

The object of the present exemplary embodiment is also achieved by executing the following processing. More specifically, a storage medium storing a program code of software for implementing the functions of the above-described exemplary embodiment is supplied to a system or an apparatus, and a computer (or CPU or Micro Processing Unit (MPU)) of the system or the apparatus reads the program code stored in the storage medium and executes the program code. In this case, the program code read from the storage medium implements the functions of the above-described exemplary embodiment, and the program code and the storage medium storing the program code constitute embodiments of the present disclosure.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-027945, filed Feb. 27, 2023, which is hereby incorporated by reference herein in its entirety.

What is claimed is:

1. An inspection apparatus connectable with a printing apparatus configured to print an image on a recording sheet to generate a print product, the inspection apparatus comprising:
one or more controllers having one or more processors and one or more memories, the one or more controllers being configured to:
register a correct answer image;
identify an item diagnosable in image diagnosis processing based on information about a print setting of the print product; and
perform first image diagnosis processing to identify a defective portion of the printing apparatus based on a read image generated by reading the print product and the correct answer image,
wherein the inspection apparatus performs the first image diagnosis processing on the identified diagnosable item and does not perform the first image diagnosis processing on an item other than the diagnosable item.

2. The inspection apparatus according to claim 1, wherein the one or more controllers are configured to identify an item diagnosable in the first image diagnosis processing based on a print setting set in a job of printing the print product.

3. The inspection apparatus according to claim 1, wherein the one or more controllers are configured to identify an item diagnosable in the first image diagnosis processing based on attribute information attached to the image.

4. The inspection apparatus according to claim 1, wherein the one or more controllers are configured to register the identified diagnosable item together with the correct answer image.

5. The inspection apparatus according to claim 1, wherein the one or more controllers are configured to identify the diagnosable item for each image printed on each page of the print product including a plurality of pages.

6. The inspection apparatus according to claim 1, wherein, in a case where the image is a monochromatic image, the inspection apparatus identifies black as the diagnosable item and identifies yellow, cyan, and magenta as image undiagnosable items.

7. The inspection apparatus according to claim 1,
wherein the inspection apparatus performs inspection processing to inspect quality of the print product based on the correct answer image and the read image, and
wherein the first image diagnosis processing and the inspection processing are performed in parallel.

8. The inspection apparatus according to claim 7, wherein, in the inspection processing, the inspection apparatus inspects the quality of the print product based on a comparison between the correct answer image and the read image.

9. The inspection apparatus according to claim 1, further comprising a display control unit configured to display a screen,
wherein, when displaying a result of image diagnosis on the screen, the display control unit displays a result of the image diagnosis for the diagnosable item and provides a display indicating that the image diagnosis has not been performed for the undiagnosable item.

10. The inspection apparatus according to claim 9, wherein, when displaying a result of image diagnosis on the screen, the display control unit displays a date and time when the first image diagnosis processing is performed.

11. The inspection apparatus according to claim 9,
wherein the one or more controllers are configured to perform second image diagnosis processing to identify a defective portion of the printing apparatus based on a diagnosis chart printed to perform image diagnosis,
wherein, in a case where an image undiagnosable item exists, the display control unit displays an object for instructing an image diagnosis unit to perform the second image diagnosis processing, and
wherein the image diagnosis unit starts execution of the image diagnosis processing upon operation of the object.

12. The inspection apparatus according to claim 1, wherein the one or more controllers are configured to perform control to:
perform second image diagnosis processing to identify a defective portion of the printing apparatus based on a diagnosis chart printed to perform image diagnosis; and
perform control to perform the second image diagnosis processing in a case where an item exists for which the image diagnosis has not been performed for a predetermined period.

13. The inspection apparatus according to claim 12, wherein the one or more controllers are configured to perform control to, in a case where there is an item not subjected to the first image diagnosis processing, perform the second image diagnosis processing upon completion of a job of printing the image.

14. The inspection apparatus according to claim 1, further comprising a setting unit configured to set an image diagnosis item,
wherein an image diagnosis unit subjects the image diagnosis item set by the setting unit to image diagnosis.

15. A method for controlling an inspection apparatus connectable with a printing apparatus configured to print an image on a recording sheet to generate a print product, the method comprising:
registering a correct answer image;
identifying an item diagnosable in image diagnosis processing based on information about a print setting of the print product; and
performing image diagnosis processing to identify a defective portion of the printing apparatus having generated the print product for the identified diagnosable item and not performing the image diagnosis processing on an item other than the diagnosable items, based on a read image generated by reading the print product and the correct answer image.
